(19) United States
(12) Patent Application Publication
(10) Pub. No.: US 2015/0365634 A1
(43) Pub. Date: Dec. 17, 2015

(54) IMAGE RECOGNITION SYSTEM

(71) Applicant: Chin-Teng Lin, (US)

(72) Inventors: Chin-Teng Lin, New Taipei City (TW); Chao-Ting Hong, New Taipei City (TW)

(21) Appl. No.: 14/304,995

(22) Filed: Jun. 16, 2014

(51) Int. Cl. H04N 7/18; G06K 9/46; G06K 9/62; H04L 29/08

(52) U.S. Cl. CPC H04N 7/183; H04L 67/10; G06K 9/4604; G06K 9/6267

(57) ABSTRACT

The image recognition system contains a server host and a local host data-linked to the server host. The server host contains a server modeling device. The local host contains a local capturing device, a local recognition device, and a local data device. The local capturing device captures an image of a to-be-identified object. The image is processed by the local recognition device to extract features. The local data device attempts to classify and identify the object based on the features extracted. If the local host fails to identify the object, the captured image is delivered to the server host and the server modeling device attempts to classify and identify the object. If the object is identified, a model information about the object is then sent back to the local host and the local data device stores the newly received model information.

### BACKGROUND OF INVENTION

(a) Technical Field of the Invention

The present invention is generally related to image recognition, and more particular to an image recognition system capable of learning the identification of new objects.

(b) Description of the Prior Art

A conventional image recognition system usually contains an image capturing device, a storage device, and a comparison device. The storage device contains images of different objects from various perspectives. The image capturing device captures at least an image of a to-be-identified object. The comparison device compares the captured images against the images stored in the storage device. Then, usually a number of objects (i.e., candidates) are considered as similar or identical to the to-be-identified object, and more detailed comparison is conducted between the captured images and the candidates' images from various perspectives. Finally, the to-be-identified object is recognized as one of the objects stored in the storage device.

It is of course possible that to-be-identified object cannot be recognized as described above. Some conventional image recognition systems provide means for adding the captured images into the storage device so that the same object can be recognized subsequently. However, this is usually a troublesome process and has to be repeated every time the appearance of an object has changed.

### SUMMARY OF THE INVENTION

A major objective of the present invention is to achieve learning the identification of new objects.

To accomplish the objective, the image recognition system contains a server host and a local host data-linked to the server host. The server host contains a server modeling device. The local host contains a local capturing device, a local recognition device, and a local data device. The local capturing device captures an image of a to-be-identified object. The image is processed by the local recognition device to extract features. The local data device attempts to classify and identify the object based on the features extracted. If the local host fails to identify the object, the captured image is delivered to the server host and the server modeling device attempts to classify and identify the object. If the object is identified, a model information about the object is then sent back to the local host and the local data device stores the newly received model information.

If the server host is not able to identify the object either, an operator defines and adds a model information about the object in the server modeling device. As such, the present invention obviates the shortcomings of the prior art and achieves learning the identification of new objects.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an image recognition system according to an embodiment of the present invention.

FIG. 2 is a functional block diagram showing the image recognition system of FIG. 1.

FIG. 3 is a functional block diagram showing an image recognition system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

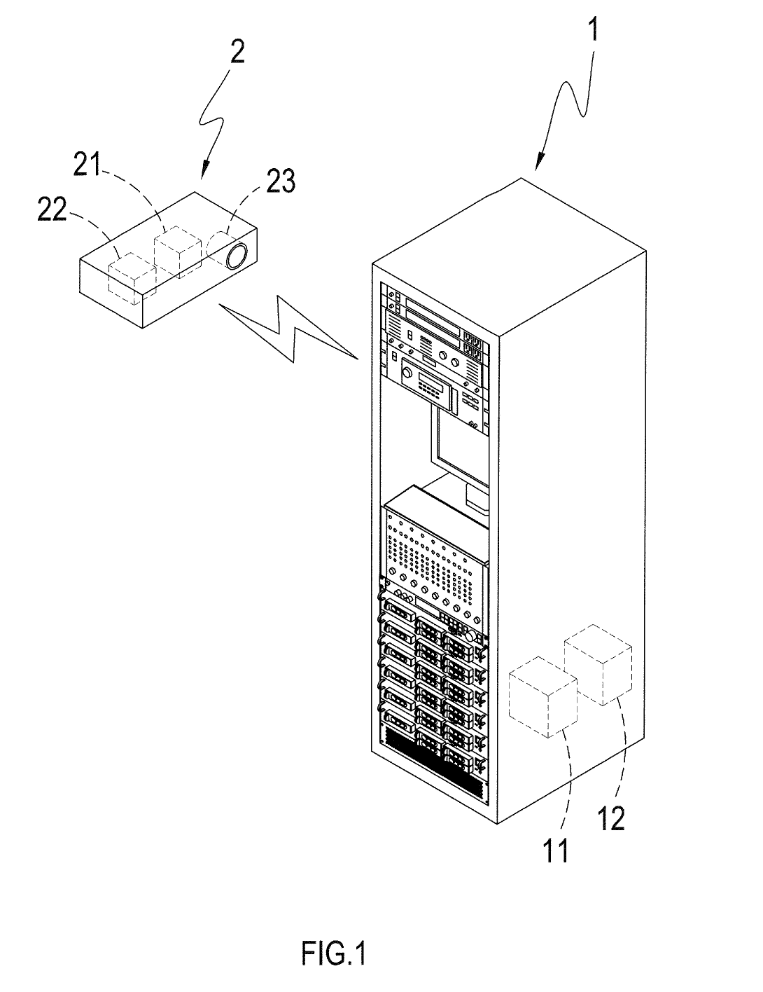

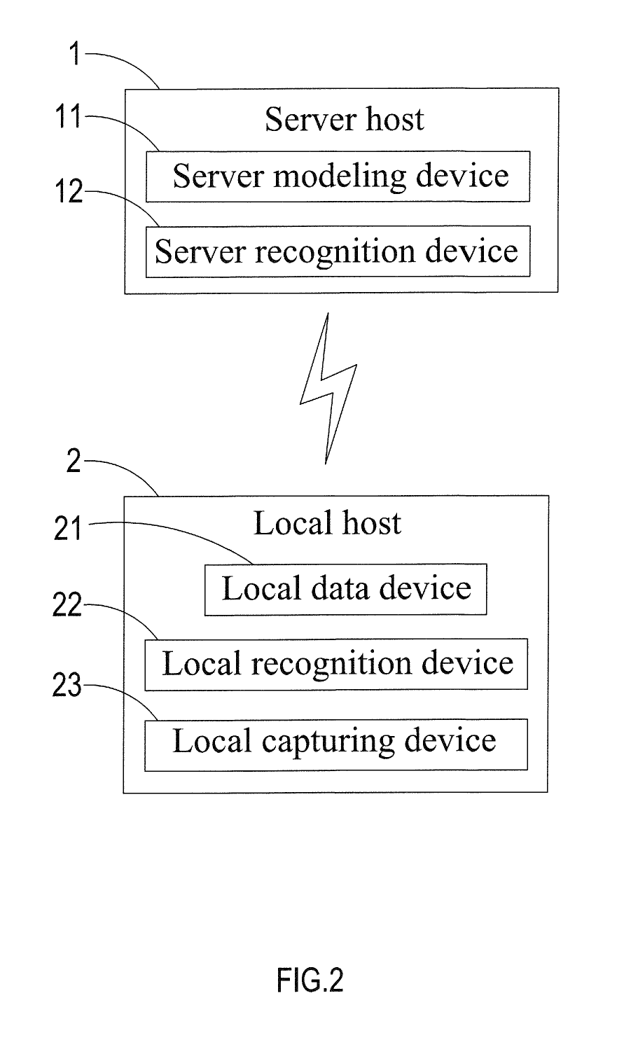

FIGS. 1 and 2 are schematic and functional block diagrams showing an image recognition system according to an embodiment of the present invention. As illustrated, the image recognition system contains a server host 1 and a local host 2 data-linked to the server host 1. The server host 1 contains a server modeling device 11 and a server recognition device 12 data-linked to the server modeling device 11. The local host 2 contains a local capturing device 23, a local recognition device 22 data-linked to the local capturing device 23, and a local data device 21 data-linked to the local recognition device 22.

The operation of the image recognition system is as follows. The local capturing device 23 is activated to capture an image of a to-be-identified object. The image is then processed by the local recognition device 22 to extract features. The local data device 21 attempts to classify and identify the object based on the features extracted.

If the local host 2 fails to identify the object, the captured image is delivered to the server host 1. The server recognition device 12 extracts the features and the server modeling device 11 attempts to classify and identify the object. If the object is identified, a model information about the object is then sent back to the local host 2 and the local data device 21 stores the newly received model information. The local host 2 thereby learns the identification of the object and is able to identify the same object subsequently.

If the server host 1 is not able to identify the object either, an operator defines and adds a model information about the object in the server modeling device 11 so that the server modeling device 11 is able to identify the object subsequently.

The local host 2 can obtain model information from the server modeling device 11 through one of the following means: memory card, flash drive, hard disk, optical disk, network, Bluetooth, infrared, and near-field communication.

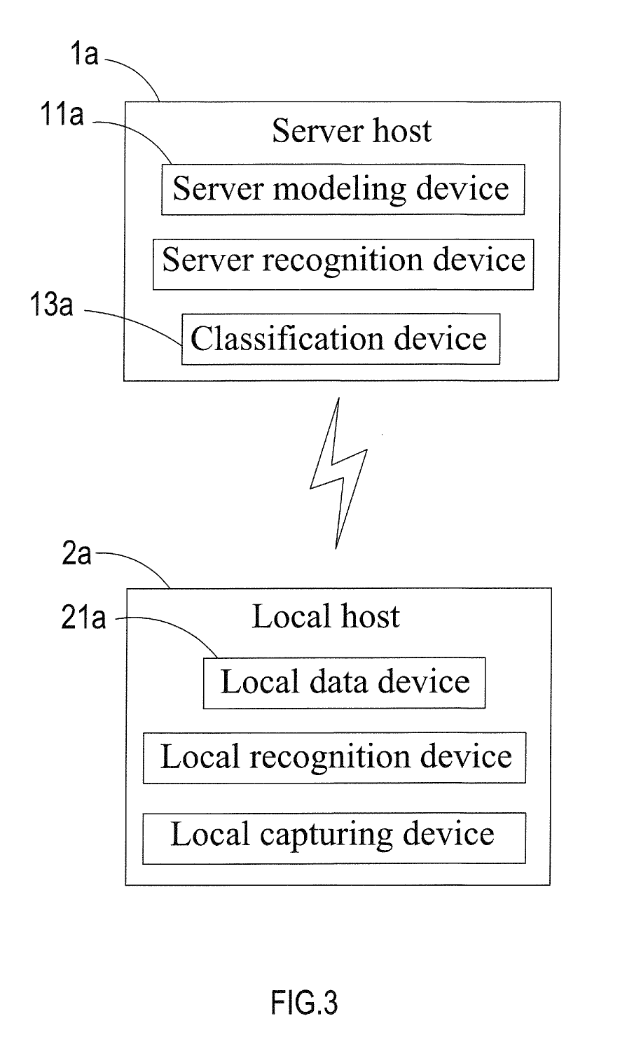

FIG. 3 is a functional block diagram showing an image recognition system according to another embodiment of the present invention. As illustrated, the image recognition system contains a server host 1a and a local host 2a data-linked to the server host 1a. The server host 1a contains a server modeling device 11a. The local host 2a contains a local data device 21a. The difference from the previous embodiment is that the server host 1a further contains a classification device 13a data-linked to the server modeling device 11a. The classification device 13a produces at least a classification (i.e., the type of objects, such as pen type of objects or cup type of objects) as a simplified model information. The classification device 13a is able to data-link to the local host 2a so as to update the model information about a type of objects in the local data device 21a. The update therefore can be conducted quickly and consumes less memory. The model information is organized by classifications and as such the recognition speed and accuracy are both enhanced.

Therefore, the advantages of the present invention over the prior art are as follows.

First, the collaboration between the server modeling device 11, the server recognition device 12, the local data device 21, the local recognition device 22, and the local capturing device 23 achieves learning the identification of new objects.

Second, the classification device 13a assists the server modeling device 11a and the local data device 21a to achieve faster recognition and to consume less memory.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An image recognition system, comprising:
a server host comprising a server modeling device; and
at least a local host data-linked to the server host, the local host comprising a local capturing device, a local recognition device data-linked to the local capturing device, and a local data device data-linked to the local recognition device;
wherein the local capturing device captures an image of a to-be-identified object; the local recognition device extract features from the captured image; the local data device attempts to classify and identify the object based on the features extracted.

2. The image recognition system according to claim 1, wherein, if the local host fails to identify the object, the captured image is delivered to the server host.

3. The image recognition system according to claim 2, wherein the server host further comprises a server recognition device; the server recognition device extracts features from the captured image; the server modeling device attempts to classify and identify the object using the extracted features; if the object is identified, a model information about the object is sent back to the local host; and the local data device stores the newly received model information.

4. The image recognition system according to claim 2, wherein, if the server host is not able to identify the object, an operator defines and adds a model information about the object in the server modeling device.

5. The image recognition system according to claim 1, wherein an operator defines and adds model information into the server modeling device.

6. The image recognition system according to claim 1, wherein the local host obtains model information from the server modeling device through one of the following means: memory card, flash drive, hard disk, optical disk, network, Bluetooth, infrared, and near-field communication.

7. The image recognition system according to claim 1, wherein the server host further comprises a classification device data-linked to the server modeling device; the classification device produces at least a classification; and the classification device is data-linked to the local host so as to update the model information in the local data device.
